(19) United States
(12) Patent Application Publication
(10) Pub. No.: US 2023/0100763 A1
(43) Pub. Date: Mar. 30, 2023

(54) DRIVE UNIT AND ROBOT

(71) Applicant: SEIKO EPSON CORPORATION, Tokyo (JP)

(72) Inventor: Hidenori HAMA, SHIOJIRI-SHI (JP)

(21) Appl. No.: 17/952,364

(22) Filed: Sep. 26, 2022

(30) Foreign Application Priority Data
Sep. 28, 2021 (JP) 2021-157610

(51) Int. Cl. B25J 9/12; B25J 9/06; B25J 17/02

(52) U.S. Cl. CPC B25J 9/126; B25J 9/06; B25J 17/0241

(57) ABSTRACT

A first drive unit includes a motor having a rotation shaft in which a through hole is provided, a drive section rotating the rotation shaft, and a first case covering at least a part of the drive section. Further, the unit includes a reducer having an input portion engaging with one end portion of the rotation shaft, an attachment portion attached to the motor, and an output portion reducing and outputting rotation of the rotation shaft. Furthermore, the unit includes a first connector fixed to a third case of the motor and coupled to first wiring coupled to outside and a second connector fixed to the attachment portion of the reducer and coupled to second wiring coupled to the outside. In addition, the first drive unit includes internal wiring passing through the through hole and coupled to the first connector and the second connector.

The present application is based on, and claims priority from JP Application Serial Number 2021-157610, filed Sep. 28, 2021, the disclosure of which is hereby incorporated by reference herein in its entirety.

### BACKGROUND

### 1. Technical Field

The present disclosure relates to a drive unit and a robot.

### 2. Related Art

In related art, drive units including reducers are used for an articulated robot or the like. An actuator with built-in reducer mechanism (corresponding to a drive unit) in JP-A-2011-2062 discloses that signal lines and power lines coupled to a hand at the distal end side of an articulated robot, the actuator with built-in reducer mechanism at the distal end side, etc. are routed through hollow portions formed in output shafts of the respective actuators with built-in reducer mechanism.

However, in JP-A-2011-2062, the signal lines and the power lines are routed through the hollow portions, and thereby, when the articulated robot is assembled using the actuators with built-in reducer mechanism and when the actuators with built-in reducer mechanism of the articulated robot are replaced, it is necessary to pull the signal lines and the power lines in and out of the hollow portions of the respective actuators with built-in reducer mechanism and the assembly work and the replacement work are complex.

### SUMMARY

A drive unit includes a motor having a rotation shaft in which a through hole is provided, a drive section rotating the rotation shaft, and a case covering at least a part of the drive section, a reducer having an input portion engaging with one end portion of the rotation shaft, an attachment portion attached to the motor, and an output portion reducing and outputting rotation of the rotation shaft, a first connector fixed to the case of the motor and coupled to first wiring coupled to outside, a second connector fixed to the attachment portion of the reducer and coupled to second wiring coupled to the outside, and internal wiring passing through the through hole and coupled to the first connector and the second connector.

A robot includes the above described drive unit, a first member having a first housing and passing the first wiring therethrough, and a second member having a second housing and passing the second wiring therethrough and relatively rotating to the first member, wherein the motor is fixed to the first member, and the output portion is fixed to the second member.

### BRIEF DESCRIPTION OF THE DRAWINGS

FIG. 1 is a side view showing a schematic configuration of a robot according to a first embodiment.

FIG. 2 is a sectional view showing a schematic configuration of a drive unit.

FIG. 3 is a sectional view showing the schematic configuration of the drive unit.

FIG. 4 is a sectional view showing a schematic configuration of a drive unit according to a second embodiment.

FIG. 5 is a sectional view showing the schematic configuration of the drive unit.

FIG. 6 is a partial sectional view showing a schematic configuration of a drive unit according to a third embodiment.

FIG. 7 is a partial sectional view showing a schematic configuration of a drive unit according to a fourth embodiment.

### DESCRIPTION OF EXEMPLARY EMBODIMENTS

As below, embodiments will be explained according to the drawings. Note that, for convenience of explanation, dimensions of the individual members in the individual drawings are appropriately exaggerated as necessary and dimensional ratios among the individual members are not necessarily equal to the actual dimensional ratios.

### 1. First Embodiment

A configuration of a robot 1 according to the embodiment will be explained.

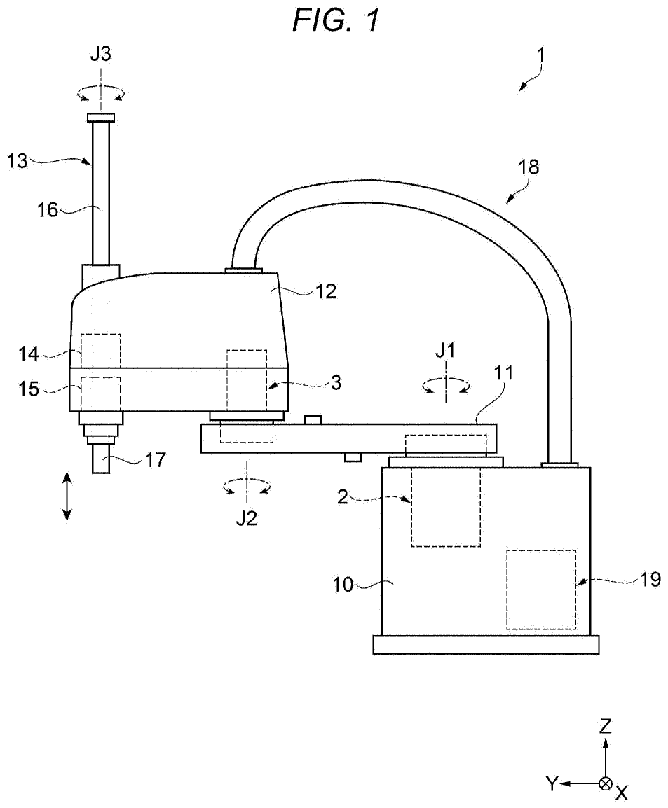

FIG. 1 is a side view showing a schematic configuration of the robot 1 according to the embodiment. The robot 1 shown in FIG. 1 is a SCARA (Selective Compliance Assembly Robot Arm) robot (horizontal articulated robot).

The robot 1 may perform work of feeding, removing, transport, assembly, etc. of precision apparatuses and components forming the precision apparatuses. In the following description, an XYZ coordinate system will be set and position relationships among the individual members will be explained with reference to the XYZ coordinate system. In this regard, vertical directions are referred to as “Z-axis directions”, horizontal directions along the length of a base 10 are referred to as “Y-axis directions”, and horizontal directions along the width of the base 10 are referred to as “X-axis directions”. Of the Z-axis directions, the direction of gravitational force is referred to as “downward direction” or “downside” and the opposite direction to the direction of gravitational force is referred to as “upward direction” or “upside”.

The robot 1 includes the base 10, a first arm 11, and a first drive unit 2. The base 10 is a part for attachment of the robot 1 to an arbitrary installation location. The base 10 is fixed to e.g. a floor surface (not shown) by bolts or the like. The installation location for the base 10 is not particularly limited to, but includes e.g. a floor, a wall, a ceiling, and a movable platform.

The first arm 11 is coupled to the upper end portion of the base 10 via the first drive unit 2 provided in the base 10. The first arm 11 is rotatable around a first axis J1 along the vertical directions (Z-axis directions) relative to the base 10. In the embodiment, as shown in FIG. 1, the rotation refers to a rotation in a rotation direction in a clockwise direction or a counterclockwise direction around the center axis.

Further, the robot 1 includes a second arm 12 and a second drive unit 3. The second arm 12 is coupled to the distal end portion of the first arm 11 via the second drive unit 3 provided in the second arm 12. The second arm 12 is rotatable around a second axis J2 along the vertical directions (Z-axis directions) relative to the first arm 11.

A working head 13 is placed in the distal end portion of the second arm 12. The working head 13 includes a spline nut 14 and a ball screw nut 15 coaxially placed in the distal end portion of the second arm 12 and a spline shaft 16 inserted through the spline nut 14 and the ball screw nut 15. The spline shaft 16 is rotatable around a third axis J3 along the vertical directions (Z-axis directions) relative to the second arm 12 and movable in the upward and downward directions (elevatable).

An end effector (not shown) is coupled to a lower distal end portion 17 of the spline shaft 16. The end effector is not particularly limited to, but includes e.g. one gripping an object to be transported and one processing an object to be processed.

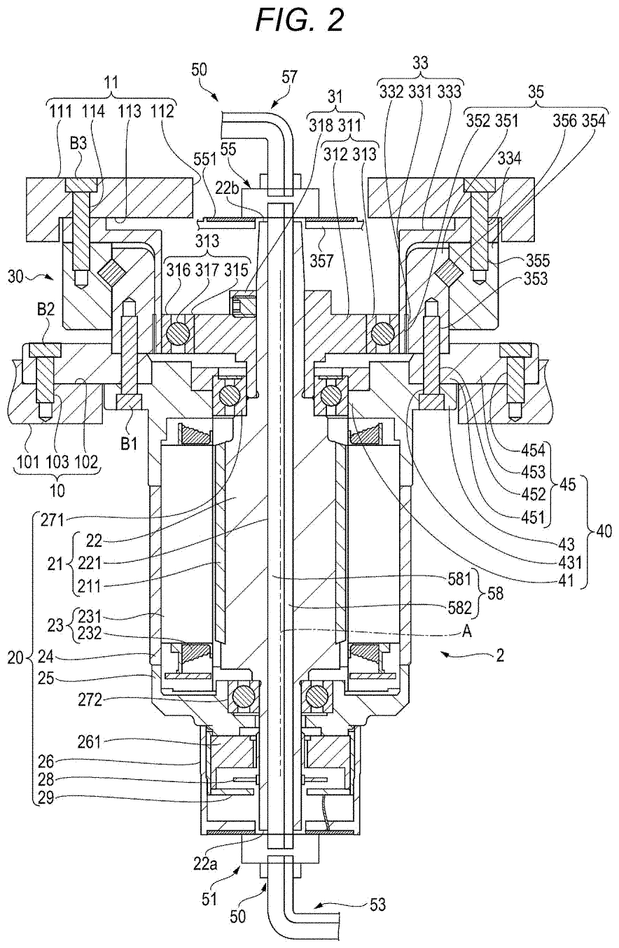

In the embodiment, of a plurality of power system wires (hereinafter, referred to as “power lines”) coupled to the individual electronic components (e.g. the second drive unit 3 etc.) placed within the second arm 12, the other wires than the power lines driving a drive section and a transmission and reception configuration section 50 (FIGS. 1 and 2), which will be described later, are guided into the base 10 through a tubular wire routing portion 18 coupling the second arm 12 and the base 10. The plurality of power system wires are collected within the base 10 and routed to a control apparatus 19 placed within the base with the wires coupled to the first drive unit 2. The control apparatus 19 performs integrated control of the robot 1.

In the embodiment, signal system wires (hereinafter, referred to as “signal lines”) for bidirectional communication via the first drive unit 2 and the second drive unit 3 are routed to the control apparatus 19 like the power lines. In the embodiment, optical fibers are used for the signal lines. Optical communications will be described later. Driving of the first drive unit 2 and the second drive unit 3 is controlled by the control apparatus 19.

In the above described robot 1, the first drive unit 2 transmits a drive force rotating the first arm 11 relative to the base 10 from the base 10 side toward the first arm 11 side. Further, the second drive unit 3 transmits a drive force rotating the second arm 12 relative to the first arm 11 from the second arm 12 side toward the first arm 11 side.

The drive units will be explained.

The first drive unit 2 and the second drive unit 3 as the drive units have the same configuration, and only the first drive unit 2 will be explained as below.

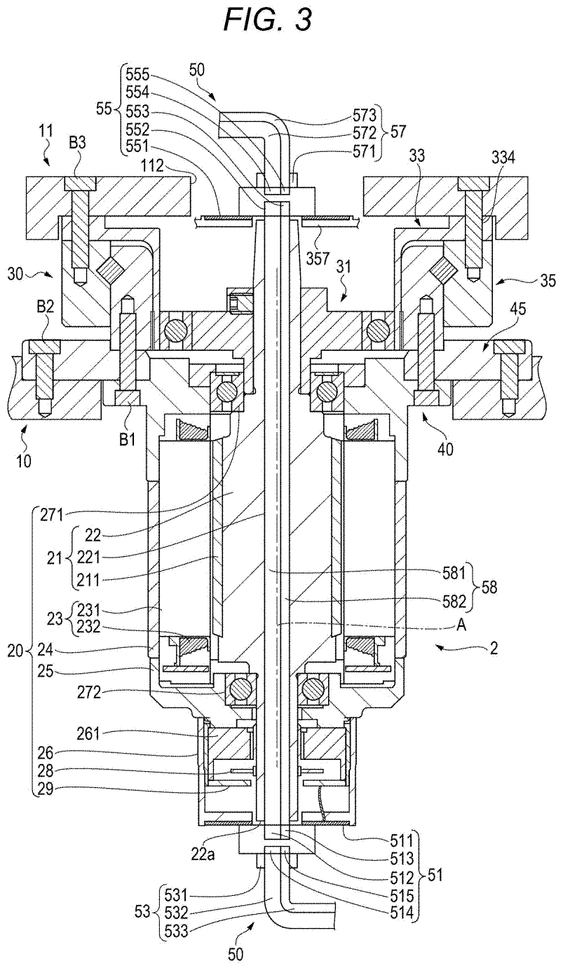

FIGS. 2 and 3 are sectional views showing a schematic configuration of the drive unit (first drive unit 2) according to the embodiment. FIGS. 2 and 3 show sections passing through the first axis J1 and parallel to the XZ-plane. FIG. 2 mainly shows a motor 20 and a reducer 30 of the first drive unit 2, the base 10, and the first arm 11 with signs attached thereto, and FIG. 3 mainly shows the transmission and reception configuration section 50 of the first drive unit 2 with signs attached thereto.

The first drive unit 2 schematically includes the motor 20, the reducer 30, a supporting member 40, and the transmission and reception configuration section 50.

The supporting member 40 has a motor supporting portion 41 as a portion supporting the motor 20, a reducer supporting portion 43 as a portion supporting the reducer 30, and, in the embodiment, an attachment plate 45 as a portion for attachment of the motor 20 of the first drive unit 2 to a base housing 101 of the base 10. Note that the motor supporting portion 41 and the reducer supporting portion 43 are integrally formed as one component. The attachment plate 45 is separately formed from the integrally formed motor supporting portion 41 and reducer supporting portion 43.

The motor supporting portion 41 is formed substantially in a cylindrical shape around a center axis A of the rotation of a rotation shaft 22 of the motor 20, which will be described later. The reducer supporting portion 43 is formed to project in a flange shape outward in the radial direction of the motor supporting portion 41. Further, in the reducer supporting portion 43, insertion holes 431 for fixing the attachment plate 45 of the supporting member 40 and an attachment portion 351 of a rigid gear 35, which will be described later, to the reducer supporting portion 43 are formed at predetermined intervals along the outer circumference.

The attachment plate 45 has a supporting portion 451 formed in an annular shape around the center axis A and having an inner region fixing the reducer 30 with the reducer supporting portion 43 of the supporting member 40, and an attachment portion 453 having an outer region fixing the motor 20 to the base 10 as a first member. Further, in the supporting portion 451 of the attachment plate 45, in the embodiment, insertion holes 452 for fixing the attachment plate 45 and the attachment portion 351 of the rigid gear 35 to the reducer supporting portion 43 of the supporting member 40 are formed correspondingly to the insertion holes 431 of the reducer supporting portion 43. Furthermore, in the attachment portion 453 of the attachment plate 45, in the embodiment, insertion holes 454 for fixing the motor 20 of the first drive unit 2 to the base housing 101 forming the base 10 are formed at predetermined intervals along the outer circumference.

A configuration and an operation of the motor 20 will be explained.

As the motor 20, the so-called servo motor is used. Specifically, an AC servo motor is used. Note that the motor 20 includes e.g. a DC servo motor. As shown in FIG. 2, the motor 20 includes a rotor 21, a stator 23, a first case 24, a second case 25, a third case 26, an optical encoder 28 as a rotation detector, and an encoder board 29 as a rotation detecting board. Further, the motor 20 includes bearings 271, 272.

In the embodiment, the encoder 28 is used as the rotation detector, however, not limited to that. For example, a resolver outputting a rotation angle as a two-phase alternating-current voltage (analog signal), a Hall sensor detecting a magnetic field and outputting an analog signal proportional to the magnitude thereof, or the like may be used.

The first case 24, the second case 25, the third case 26, and the motor supporting portion 41 of the supporting member 40 also serve as a case surrounding the motor 20.

As shown in FIG. 2, the bearings 271, 272 are placed in the center parts of the motor supporting portion 41 and the second case 25. Note that, in the embodiment, the center axis A of the rotation of the rotation shaft 22 forming the rotor 21 is the same as the first axis J1 as the center of the rotation of the first arm 11.

The bearings 271, 272 are rolling bearings including inner rings and outer rings. End sides of the rotation shaft 22 are respectively fixed by interference fit in the inner rings of the bearings 271, 272. The outer ring of one bearing 271 is supported by the motor supporting portion 41 of the supporting member 40. Further, the outer ring of the other bearing 272 is supported by the second case 25. Note that the first case 24, the second case 25, and the third case 26 are fixed to the motor supporting portion 41.

The rotation shaft 22 of the motor 20 is supported by the motor supporting portion 41 and the second case 25 via the bearings 271, 272 and rotates around the center axis A. The rotation shaft 22 is coupled to the reducer 30 in the end portion at the bearing 271 side and transmits the drive force to the reducer 30. Further, in the rotation shaft 22, in the end portion at the bearing 272 side, the encoder 28 as the rotation detector detecting the rotation of the rotation shaft 22 is placed on the outer circumferential surface of the rotation shaft 22. Accordingly, the encoder 28 rotates with the rotation of the rotation shaft 22.

The encoder board 29 as the rotation detecting board capturing the signal from the encoder 28 is fixed to a board supporting portion 261 to surround the outer circumferential surface of the rotation shaft 22 in the lower end portion than the portion of the rotation shaft 22 to which the encoder 28 is attached. Further, the encoder 28 and the encoder board 29 are surrounded by the third case 26.

The rotor 21 includes the rotation shaft 22 and a magnet 211. The rotation shaft 22 is formed in a cylindrical shape with a diameter reduced along the direction of the center axis A. Further, a hollow through hole 221 formed along the direction of the center axis A is formed in the rotation shaft 22. The rotation shaft 22 is formed using a soft magnetic material such as iron.

The magnet 211 is fixed to the outer circumferential surface around the center axis A of the rotation shaft 22. The magnet 211 has a multipole structure formed in an annular shape and having a plurality of magnetic poles arranged in the circumferential direction. The magnet 211 includes e.g. six magnet pieces and the poles are configured to be NSNSNS in the circumferential direction. The magnet 211 is surrounded by the stator 23.

The stator 23 surrounds the rotor 21 (rotation shaft 22, magnet 211) around the center axis A. The stator 23 is formed in a cylindrical shape and has coils 232 around iron cores 231 placed at predetermined intervals in the circumferential direction as respective cores.

For the motor 20 having the above described configuration, when an alternating current flows in the stator 23, the stator 23 serves as an electromagnet and the stator 23 switches between the N-pole and the S-pole because the direction and the magnitude of the current alternately switch in the alternating current. Accordingly, the stator attracts or repels the magnet 211 of the rotor 21 and the rotor 21 (rotation shaft 22) rotates.

Note that the stator 23 (iron cores 231, coils 232) functions as a drive section rotating the rotation shaft 22. Further, the first case 24 surrounds at least part of the rotor 21 and the stator 23, that is, coverts at least part of the drive section.

A configuration and an operation of the reducer 30 will be explained.

The reducer 30 is a reducer called a wave gearing reducer using a wave gearing mechanism. The reducer 30 reduces and outputs the rotation of the drive force input from the rotation shaft 22 of the motor 20. At the output side of the reducer 30, torque proportional to the reduction ratio may be obtained.

As shown in FIG. 2, the reducer 30 includes a wave generator 31, a flexible gear 33 as a flexible external gear, and the rigid gear 35 including an internal gear. In the embodiment, the wave generator 31 serves as an input portion engaging with one end portion of the rotation shaft 22. Further, in the embodiment, the flexible gear 33 serves as an output portion reducing and outputting the rotation of the rotation shaft 22. Furthermore, in the embodiment, the rigid gear 35 serves as an attachment portion attached to the motor 20.

In the embodiment, the rigid gear 35 functions as the attachment portion, and the flexible gear 33 functions as the output portion. However, the flexible gear 33 may function as the attachment portion and the rigid gear 35 may function as the output portion.

The rigid gear 35 is a gear formed using a rigid body not substantially flexing in the radial direction of the center axis A, and is an annular internal gear having internal teeth 352. In the embodiment, the rigid gear 35 is a spur gear. That is, the internal tooth 352 has a tooth trace parallel to the center axis A. Note that the tooth trace of the internal tooth 352 may tilt relative to the center axis A. That is, the rigid gear 35 may be a helical gear or a double-helical gear.

The rigid gear 35 includes two portions of the attachment portion 351 for attachment of the rigid gear 35 to the reducer supporting portion 43 of the supporting member 40 and a coupling portion 354 for coupling to the arm (the first arm 11 in FIG. 1) of the robot 1.

The attachment portion 351 is formed with the above described internal teeth 352 in the lower end portion at the inner side in the radial direction of the center axis A. In the attachment portion 351, attachment screw holes 353 for attachment to the reducer supporting portion 43 of the supporting member 40 via the supporting portion 451 of the attachment plate 45 are formed. The attachment screw holes 353 are formed correspondingly to the insertion holes 431, 452. In the embodiment, fixing screw holes 355 for coupling to the first arm 11 are formed in the coupling portion 354.

Note that the attachment portion 351 and the coupling portion 354 are coupled by a bearing 356 and the coupling portion 354 is configured to be rotatable relative to the attachment portion 351. The bearing 356 is the so-called cross roller bearing having rollers alternately placed at angles +45° and −45° relative to the rotation shaft and receiving both radial and thrust loads.

The flexible gear 33 is inserted through the rigid gear 35. The flexible gear 33 is a gear including a flexible tubular portion 331 flexurally deformable in the radial direction of the center axis A. Further, the flexible gear 33 is an external gear including external teeth 332 meshing with the internal teeth 352 of the rigid gear 35. The number of teeth of the flexible gear 33 is smaller than the number of teeth of the rigid gear 35.

The flexible gear 33 is formed in a top hat shape including a flange portion 333 extending outward in the radial direction of the center axis A from the upper end part of the tubular portion 331, in addition to the tubular portion 331. The external teeth 332 are formed at the outside in the radial direction of the center axis A in the lower end part of the tubular portion 331. In the flexible gear 33, insertion holes 334 for fixing the reducer 30 to the first arm 11 and to the coupling portion 354 of the rigid gear 35 are formed at predetermined intervals along the outer circumference of the flange portion 333. The insertion holes 334 are formed correspondingly to the fixing screw holes 355.

The wave generator 31 includes a wave generating unit 311 and a fixing portion 318. The fixing portion 318 is formed using e.g. a screw or a bolt and fixes the wave generating unit 311 and the rotation shaft 22 of the motor 20 from the radial direction of the center axis A.

The wave generating unit 311 includes a main body portion 312 and a bearing 313 attached to the outer circumference of the main body portion 312. The main body portion 312 is formed to have the outer circumference in an elliptical shape or an oval shape as seen from the direction of the center axis A.

The bearing 313 is a rolling bearing including flexible inner ring 315 and outer ring 316 and a plurality of balls 317 placed between the rings. The inner ring 315 is fitted around the outer circumference of the main body portion 312 and elastically deforms in an elliptical shape or an oval shape along the outer circumferential surface of the main body portion 312. With the deformation, the outer ring 316 also elastically deforms in an elliptical shape or an oval shape. Further, the outer circumferential surface of the inner ring 315 and the inner circumferential surface of outer ring 316 are respectively orbital surfaces for guiding and rolling the plurality of balls 317 along the circumferential direction. Furthermore, the plurality of balls 317 are held by a holder (not shown) so that the distances from each other in the circumferential direction may be kept constant.

According to the above described configuration, the wave generator 31 is located inside of the flexible gear 33 and movable around the center axis A. The wave generating unit 311 contacts the inner circumferential surface of the tubular portion 331 of the flexible gear 33, and flexes the tubular portion 331 in an elliptical shape or an oval shape as a long axis and a short axis and partially meshes the external teeth 332 with the internal teeth 352 of the rigid gear 35. Here, the flexible gear 33 and the rigid gear 35 are meshed with each other inside and outside rotatably around the center axis A.

In the reducer 30, when the drive force from the above described motor 20 is input to the wave generator 31, the flexible gear 33 and the rigid gear 35 relatively rotate around the center axis A due to the difference in number of teeth while moving the meshing position with each other in the circumferential direction. Thereby, the rotation of the drive force input to the wave generator 31 from the rotation shaft 22 of the motor 20 as the drive source is reduced and output from the flexible gear 33. Further, at the output side, torque proportional to the reduction ratio may be obtained. That is, the reducer 30 with the wave generator 31 at the input side and the flexible gear 33 at the output side may be realized.

In the embodiment, the attachment portion 351 of the rigid gear 35 meshing with the flexible gear 33 is fixed to the supporting member 40, and the flexible gear 33 rotates with the coupling portion 354 of the rigid gear 35. Therefore, in the embodiment, the drive force from the motor 20 is input to the wave generator 31 and, when the wave generator 31 rotates, the flexible gear 33 moves the meshing position with each other with the rigid gear 35 (attachment portion 351) in the circumferential direction and relatively rotates around the center axis A due to the difference in number of teeth. Note that the rotation direction of the wave generator 31 and the rotation direction of the flexible gear 33 are opposite.

An example of an assembly method of the first drive unit 2 in the embodiment will be briefly explained.

Note that the assembly of the motor 20 will be omitted. Further, the order of assembly is not limited to that described as below.

First, the motor 20 is assembled in the supporting member 40 (motor supporting portion 41). Here, the first case 24 of the motor 20 is in contact with the motor supporting portion 41. Further, the outer ring of the bearing 271 with the inner ring fixed by interference fit around the rotation shaft 22 of the motor 20 in advance is supported by the inner circumferential surface of the motor supporting portion 41.

Then, in the supporting member 40, the separately formed attachment plate 45 is placed at the upside of the reducer supporting portion 43. In this case, the position is adjusted so that the insertion holes 431 formed in the reducer supporting portion 43 and the insertion holes 452 formed in the supporting portion 451 of the attachment plate 45 may overlap.

Then, the main body portion 312 of the wave generator 31 of the reducer 30 and the rotation shaft 22 of the motor 20 are fixed from the radial direction of the center axis A by the fixing portion 318. Note that the fixing method is not particularly limited, but may be fixation by an adhesive agent, welding, or the like, not the fixation by the screw or the bolt.

Then, as sub-assembly, the flexible gear 33 is assembled in the rigid gear 35. Specifically, the tubular portion 331 of the flexible gear 33 is inserted from upside along the inner circumferential surface of the attachment portion 351 of the rigid gear 35. Then, the flange portion 333 of the flexible gear 33 is brought into contact with the upper surface of the coupling portion 354. Thereby, the external teeth 332 of the flexible gear 33 and the internal teeth 352 of the rigid gear 35 sectionally face each other.

Then, the sub-assembled rigid gear 35 and flexible gear 33 are engaged with the outer circumferential surface of the wave generator 31 from above. Thereby, the tubular portion 331 of the flexible gear 33 elastically deforms along the outer circumferential surface of the wave generator 31 (the outer circumferential surface of the outer ring 316 of the bearing 313) and engages and the external teeth 332 of the flexible gear 33 and the internal teeth 352 of the rigid gear 35 partially mesh with each other. In this case, the position is adjusted so that the attachment screw holes 353 formed in the attachment portion 351 of the rigid gear 35 and the insertion holes 452 of the attachment plate 45 may overlap.

Then, the bolts B1 are inserted from the downside of the reducer supporting portion 43 through the insertion holes 431 of the reducer supporting portion 43 and the insertion holes 452 of the attachment plate 45 and screwed in the attachment screw holes 353 of the rigid gear 35. Thereby, the attachment portion 351 of the rigid gear 35 is attached to the supporting member 40 with the attachment plate 45.

By the assembly, the motor 20 and the reducer 30 are fixed.

Note that, by the above described assembly, with the motor 20 and the reducer 30 fixed, the transmission and reception configuration section 50, which will be described later, is placed, specifically, internal wiring 58 is placed in the through hole 221 and a first connector 51 and a second connector 55 are placed, and thereby, the assembly of the first drive unit 2 is completed. In this state, the internal wiring 58 is coupled to the first connector 51 and the second connector 55. Note that, in the state, first wiring 53 (first connecting portion 531) is not coupled to the first connector 51, which will be described later, and second wiring 57 (second connecting portion 571) is not coupled to the second connector 55, which will be described later.

Assembly of the first drive unit 2 in the robot 1 will be explained.

In the embodiment, the first drive unit 2 is a drive unit relatively rotating the first arm 11 as a second member to the base 10 as the first member.

In the embodiment, the first drive unit 2 fixes the motor 20 to the base 10 as the first member. Specifically, in the first drive unit 2, the attachment plate 45 of the supporting member 40 is fixed to the base housing 101 as a first housing forming the base 10.

In the base housing 101, fixing screw holes 103 having shapes conformed to the outer diameter of the attachment plate 45 (e.g. step portions 102) are formed correspondingly to the insertion holes 454. The supporting member 40 is fixed to the base 10 in the manner that the supporting member 40 (attachment plate 45) is positioned in the step portions 102 from the upside of the base housing 101, and then, bolts B2 are inserted through the insertion holes 454 from the upside and screwed into the fixing screw holes 103. Thereby, the first wiring 53 is routed inside of the base 10 as the first member.

In the embodiment, the first drive unit 2 fixes the flexible gear 33 as the output portion to the first arm 11 as the second member. Specifically, in the first drive unit 2, the flexible gear 33 of the reducer 30 is fixed to a first arm housing 111 as a second housing forming the first arm 11.

In the first arm housing 111, insertion holes 114 having shapes conformed to the outer diameter of the flexible gear 33 (e.g. step portions 113) are formed correspondingly to the insertion holes 334 in addition to an opening portion 112, which will be described later. The flexible gear 33 is fixed to the first arm 11 in the manner that the flexible gear 33 (flange portion 333) is positioned in the step portions 113 from the downside of the first arm housing 111, and then, bolts B3 are inserted through the insertion holes 114, 334 from the upside and screwed into the fixing screw holes 355. Thereby, the second wiring 57 is routed inside of the first arm 11 as the second member.

By the above described assembly, in the embodiment, the drive force by the rotation of the motor 20 fixed to the base 10 is input to the wave generator 31 from the base 10 fixed to a floor surface or the like and, when the wave generator 31 rotates, the first arm 11 fixed to the flexible gear 33 rotates around the center axis A (first axis J1) relative to the base 10.

A configuration and an operation of the transmission and reception configuration section 50 will be explained.

The transmission and reception configuration section 50 is a section forming the first drive unit 2, in which the signal lines and the power lines are routed.

As the operation of the transmission and reception configuration section 50, in the first drive unit 2, for example, when the rotation speed of the motor 20 is detected, a signal for an instruction to detect the rotation speed from the control apparatus 19 is received by optical communication and data of the rotation speed of the motor 20 detected by the first drive unit 2 is transmitted to the control apparatus 19 by optical communication. Thereby, the control apparatus 19 may properly control and operate the rotation of the first arm 11. Further, in the embodiment, transmission and reception between the second drive unit 3 placed in the second arm 12 and the control apparatus 19 are performed via the transmission and reception configuration section 50 of the first drive unit 2.

In a case where a hand (not shown) gripping an object or the like is provided as an end effector of the robot 1 shown in FIG. 1 and a signal of a force sensor such as a tactile sensor measuring the gripping force provided in the hand is transmitted to the control apparatus 19 or the like, the transmission is performed via the second drive unit 3 and the first drive unit 2. Further, in a case where a camera is placed in the spline shaft 16 shown in FIG. 1 or the like, transmission of an image signal by imaging using the camera to the control apparatus 19 or the like is performed via the second drive unit 3 and the first drive unit 2. Note that, when the number of signal lines increases, the wavelength of light may be changed and communication for the necessary number of lines may be performed.

As the operation of the transmission and reception configuration section 50, for example, in the first drive unit 2, when the motor 20 is driven, drive power (e.g. alternating current) from the control apparatus 19 is transmitted to the first connector 51 via the first wiring 53 (first power line 533) and the drive power is supplied to the stator 23 (coils 232) to rotate the motor 20.

Further, for example, in the second drive unit 3, when the motor 20 is driven, the drive power (e.g. alternating current) from the control apparatus 19 is transmitted to the second connector 55 of the second drive unit 3 via the first drive unit 2. After transmitted to the first connector 51 via the internal wiring 58 (power line 582) of the second drive unit 3, the drive power is supplied to the stator 23 (coils 232) to rotate the motor 20.

The transmission and reception configuration section 50 includes the first connector 51, the first wiring 53, the second connector 55, the second wiring 57, and the internal wiring 58.

The transmission and reception configuration section 50 is configured so that the internal wiring 58 is placed in the hollow through hole 221 provided in the rotation shaft 22 for communications of signals and power. The internal wiring 58 has a signal line 581 and the power line 582. The signal line 581 is formed using an optical fiber in the embodiment. The power line 582 is formed using a normal conducting wire.

The signal line 581 and the power line 582 are aligned and fixed in the length direction. In the embodiment, the internal wiring 58 is coupled to the first connector 51 and the second connector 55 in both end portions. The internal wiring 58 placed in the through hole 221 of the rotation shaft 22 is fixed, not following the rotation of the rotation shaft 22.

As shown in FIG. 3, the first connector 51 includes a first transmitting and receiving circuit board 511, a signal line terminal 512 and a power line terminal 513 at the internal wiring 58 side, and a signal line terminal 514 and a power line terminal 515 at the first wiring 53 side. The first connector 51 is fixed to the lower surface side of the third case 26 of the motor 20 at a lower end portion 22a side of the rotation shaft 22.

The first connector 51 has the signal line terminal 512 at the internal wiring 58 side and is coupled to the signal line 581 of the internal wiring 58. Further, the first connector 51 has the power line terminal 513 at the internal wiring 58 side and is coupled to the power line 582 of the internal wiring 58.

The first connector 51 is coupled to the first wiring 53 coupled to the outside. Here, “outside” corresponds to the control apparatus 19 in the embodiment.

The first transmitting and receiving circuit board 511 is coupled to the encoder board 29 and transmits and receives electrical signals to and from the encoder board 29. The encoder board 29 of the embodiment is separately formed from the first transmitting and receiving circuit board 511 (first connector 51). Further, the first transmitting and receiving circuit board 511 is coupled to the stator 23 as the drive section and supplies power to the stator 23 (coils 232).

The signal line terminal 512 at the internal wiring 58 side of the first connector 51 includes a light emitting device and a light receiving device (both not shown) coupled to the lower end portion as one end portion of the signal line 581 of the internal wiring 58 via the first transmitting and receiving circuit board 511. The power line terminal 513 at the internal wiring 58 side of the first connector 51 includes a connecting portion (not shown) coupled to the lower end portion as one end portion of the power line 582 of the internal wiring 58 via the first transmitting and receiving circuit board 511.

When the first connector 51 (first transmitting and receiving circuit board 511) is fixed to the lower surface side of the third case 26, one end portion of the signal line 581 of the internal wiring 58 and the signal line terminal 512 at the internal wiring 58 side are coupled to be optically communicable. Further, when the first connector 51 (first transmitting and receiving circuit board 511) is fixed to the lower surface side of the third case 26, one end portion of the power line 582 of the internal wiring 58 and the power line terminal 513 at the internal wiring 58 side are coupled to be conductible.

The signal line terminal 514 at the first wiring 53 side of the first connector 51 includes a light emitting device and a light receiving device (both not shown) coupled to the end portion of the first signal line 532 of the first wiring 53 via the first transmitting and receiving circuit board 511. The power line terminal 515 at the first wiring 53 side of the first connector 51 includes a connecting portion (not shown) coupled to the end portion of the first power line 533 of the first wiring 53 via the first transmitting and receiving circuit board 511.

The first wiring 53 has the first signal line 532 and the first power line 533. The first wiring 53 is coupled to the control apparatus 19. The first signal line 532 is formed using an optical fiber like the signal line 581 of the internal wiring 58. The first power line 533 is formed using a conducting wire like the power line 582 of the internal wiring 58.

The end portions of the first signal line 532 and the first power line 533 of the first wiring 53 are formed as the first connecting portion 531. Further, the first wiring 53 is detachable from the first connector 51 (first transmitting and receiving circuit board 511) by the first connecting portion 531.

When the first wiring 53 is attached to the first connector 51, the end portion of the first signal line 532 and the signal line terminal 514 at the first wiring 53 side of the first connector 51 are coupled to be optically communicable. Further, when the first wiring 53 is attached to the first connector 51, the end portion of the first power line 533 and the power line terminal 515 at the first wiring 53 side of the first connector 51 are coupled to be conductible.

As the operation of the transmission and reception configuration section 50, for example, when the rotation speed of the motor 20 is detected in the first drive unit 2, the first transmitting and receiving circuit board 511 receives a signal for an instruction to detect the rotation speed from the control apparatus 19 by the signal line terminal 514 (light receiving device) at the first wiring 53 side of the first connector 51 via the first wiring 53 (first signal line 532).

Further, the first transmitting and receiving circuit board 511 converts the received optical signal into an electrical signal and transmits the signal to the encoder board 29. The encoder board 29 receives data of the rotation speed from the encoder 28 and transmits the data to the first transmitting and receiving circuit board 511. The first transmitting and receiving circuit board 511 converts the data of the rotation speed received from the encoder board 29 into an optical signal and transmits the optical signal by the signal line terminal 514 (light emitting device) at the first wiring 53 side.

The first signal line 532 of the first wiring 53 transmits the optical signal transmitted from the signal line terminal 514 (light emitting device) to the control apparatus 19. Thereby, the control apparatus 19 may properly control and operate the rotation angle of the first arm 11.

Further, as the operation of the transmission and reception configuration section 50, for example, in the first drive unit 2, when the motor 20 is driven, the drive power (e.g. alternating current) from the control apparatus 19 is transmitted to the first transmitting and receiving circuit board 511 via the first wiring 53 (first power line 533) by the power line terminal 515 at the first wiring 53 side of the first connector 51. Then, the first transmitting and receiving circuit board 511 supplies the transmitted drive power to the stator 23 (coils 232). Thereby, the motor 20 is rotated.

Note that the first transmitting and receiving circuit board 511 receives the optical signal input from the first wiring 53 by the signal line terminal 514 (light receiving device) at the first wiring 53 side and transmits the received optical signal from the signal line terminal 512 (light emitting device) at the internal wiring 58 side to the internal wiring 58 (signal line 581).

Reversely, the first transmitting and receiving circuit board 511 receives the optical signal input from the internal wiring 58 (signal line 581) by the signal line terminal 512 (light receiving device) at the internal wiring 58 side and transmits the received optical signal from the signal line terminal 514 (light emitting device) at the first wiring 53 side to the first wiring 53 (first signal line 532).

Note that the first transmitting and receiving circuit board 511 receives the power signal input from the first wiring 53 by the power line terminal 515 at the first wiring 53 side and transmits the received power signal from the power line terminal 513 at the internal wiring 58 side to the internal wiring 58 (power line 582).

The second connector 55 includes a second transmitting and receiving circuit board 551, a signal line terminal 552 and a power line terminal 553 at the internal wiring 58 side, and a signal line terminal 554 and a power line terminal 555 at the second wiring 57 side like the first connector 51. As shown in FIGS. 2 and 3, the second connector 55 is fixed to a supporting member 357 provided in the attachment portion 351 of the rigid gear 35 as the attachment portion of the reducer 30 at an upper end portion 22b side of the rotation shaft 22. In other words, the second connector 55 is fixed to the rigid gear 35 as the attachment portion of the reducer 30.

As shown in FIG. 3, the second connector 55 has the signal line terminal 552 at the internal wiring 58 side and is coupled to the signal line 581 of the internal wiring 58. Further, the second connector 55 has the power line terminal 553 at the internal wiring 58 side and is coupled to the power line 582 of the internal wiring 58.

The second connector 55 is placed in a region of the opening portion 112 formed in the first arm housing 111, which will be described later, of the first arm 11 to which the output side of the first drive unit 2 is fixed. The second connector 55 is coupled to the second wiring 57 coupled to the outside. Here, “outside” corresponds to the second connector 55 of the second drive unit 3 in the embodiment.

The signal line terminal 552 at the internal wiring 58 side of the second connector 55 includes a light emitting device and a light receiving device (both not shown) coupled to the upper end portion as the other end portion of the signal line 581 of the internal wiring 58 via the second transmitting and receiving circuit board 551. The power line terminal 553 at the internal wiring 58 side of the second connector 55 includes a connecting portion (not shown) coupled to the upper end portion as the other end portion of the power line 582 of the internal wiring 58 via the second transmitting and receiving circuit board 551.

When the second connector 55 (second transmitting and receiving circuit board 551) is fixed to the supporting member 357, the other end portion of the signal line 581 of the internal wiring 58 and the signal line terminal 552 at the internal wiring 58 side are coupled to be optically communicable. Further, when the second connector 55 (second transmitting and receiving circuit board 551) is fixed to the supporting member 357, the other end portion of the power line 582 of the internal wiring 58 and the power line terminal 553 at the internal wiring 58 side are coupled to be conductible.

The signal line terminal 554 at the second wiring 57 side of the second connector 55 includes a light emitting device and a light receiving device (both not shown) coupled to the end portion of the second signal line 572 of the second wiring 57 via the second transmitting and receiving circuit board 551. The power line terminal 555 at the second wiring 57 side of the second connector 55 includes a connecting portion (not shown) coupled to the end portion of the second power line 573 of the second wiring 57 via the second transmitting and receiving circuit board 551.

The second wiring 57 has the second signal line 572 and the second power line 573. The second wiring 57 is coupled to the second connector 55 of the second drive unit 3. The second signal line 572 is formed using an optical fiber like the signal line 581 of the internal wiring 58. The second power line 573 is formed using a conducting wire like the power line 582 of the internal wiring 58.

The end portions of the second signal line 572 and the second power line 573 of the second wiring 57 are formed as the second connecting portion 571. Further, the second wiring 57 is detachable from the second connector 55 (second transmitting and receiving circuit board 551) by the second connecting portion 571.

When the second wiring 57 is attached to the second connector 55, the end portion of the second signal line 572 and the signal line terminal 554 at the second wiring 57 side of the second connector 55 are coupled to be optically communicable. Further, when the second wiring 57 is attached to the second connector 55, the end portion of the second power line 573 and the power line terminal 555 at the second wiring 57 side of the second connector 55 are coupled to be conductible.

As the operation of the transmission and reception configuration section 50, for example, in the first drive unit 2, the second transmitting and receiving circuit board 551 receives a signal for an instruction to detect the rotation speed of the motor 20 of the second drive unit 3 from the control apparatus 19 through the first wiring 53 (first signal line 532) and the internal wiring 58 (signal line 581) via the signal line terminal 552 (light receiving device) at the internal wiring 58 side. Then, the second transmitting and receiving circuit board 551 transmits the received signal to the second wiring 57 (second signal line 572) by the signal line terminal 554 (light emitting device) at the second wiring 57 side. Then, the second signal line 572 of the second wiring 57 transmits the optical signal transmitted from the signal line terminal 554 (light emitting device) at the second wiring 57 side to the second connector 55 of the second drive unit 3.

A case where the first drive unit 2 is replaced is briefly explained.

As shown in FIG. 2, when the first drive unit 2 is replaced, the first drive unit 2 is detached from the base 10 and the first arm 11.

First, in the first drive unit 2, the first connecting portion 531 coupled to the first connector 51 is pulled out from the first connector 51, and thereby, the first wiring 53 is detached from the first drive unit 2. Similarly, in the first drive unit 2, the second connecting portion 571 coupled to the second connector 55 is pulled out from the second connector 55, and thereby, the second wiring 57 is detached from the first drive unit 2.

Then, the bolts B2 are detached, and thereby, the fixation between the base housing 101 and the supporting member 40 is released. Further, the bolts B3 are detached, and thereby, the fixation between the first arm housing 111 and the flexible gear 33 is released.

In the above described manner, the first drive unit 2 may be detached from the base 10 and the first arm 11.

According to the embodiment, the following effects may be obtained.

The first drive unit 2 of the embodiment includes the motor 20 having the rotation shaft 22 in which the through hole 221 is provided, the drive section (rotor 21 and stator 23) rotating the rotation shaft 22, and the case (first case 24) covering at least a part of the drive section (rotor 21 and stator 23). Further, the first drive unit 2 includes the reducer 30 having the input portion (wave generator 31) engaging with one end portion of the rotation shaft 22, the attachment portion (rigid gear 35) attached to the motor 20, and the output portion (flexible gear 33) reducing and outputting the rotation of the rotation shaft 22. Furthermore, the first drive unit 2 includes the first connector 51 fixed to the case (third case 26) of the motor 20 and coupled to the first wiring 53 coupled to the outside and the second connector 55 fixed to the attachment portion (rigid gear 35) of the reducer 30 and coupled to the second wiring 57 coupled to the outside. In addition, the first drive unit 2 includes the internal wiring 58 passing through the through hole 221 and coupled to the first connector 51 and the second connector 55.

According to the configuration, signals and power may be transmitted and received via the internal wiring 58 passing through the through hole 221 of the rotation shaft 22 and coupled to the first connector 51 and the second connector 55.

Note that, when the first drive unit 2 is replaced, the first wiring 53 (first connecting portion 531) coupled to the first connector 51 is pulled out, and the second wiring 57 (second connecting portion 571) coupled to the second connector 55 is pulled out. Then, the bolts B2, B3 are detached, and thereby, the fixation between the first drive unit 2 and the base 10 and between the first drive unit 2 and the first arm 11 is released. Thereby, the first drive unit 2 to be replaced may be detached. Then, a new first drive unit 2 is fixed to the base 10 and the first arm 11, the first wiring 53 (first connecting portion 531) is inserted into the first connector 51 and the second wiring 57 (second connecting portion 571) is inserted into the second connector 55 for replacement.

Therefore, when an articulated robot is assembled using the first drive unit 2 or when the first drive unit 2 is replaced, it is not necessary to pull in and pull out signal lines and power lines (corresponding to the internal wiring 58) into or from through holes of the respective drive units unlike the related art, and assembly work and replacement work may be easily performed.

In a robot of the related art, replacement of the drive unit is not assumed. A single signal line couples from the base through the hollow portion of the drive unit to the hand and the camera of the spline shaft. Accordingly, for replacement of the drive unit, it is necessary to perform work to detach and attach the signal line from and to the hand or the like because the unit is not replaceable with the signal line attached to the hand or the like. Alternatively, when the signal line passes through the hollow portion of another drive unit, it is also necessary to perform work to pull out and insert the signal line from and into the other drive unit. In comparison to the drive unit of the related art requiring the complex work, the first connector 51 and the second connector 55 are provided in the first drive unit, and thereby, the first drive unit 2 can be replaced only by the above described wiring work.

In the first drive unit 2 of the embodiment, the internal wiring 58 has the signal line 581 and the power line 582. The first connector 51 and the second connector 55 each have the signal line terminal and the power line terminal and are coupled to the signal line 581 and the power line 582 of the internal wiring 58.

Note that the signal line terminal of the first connector 51 has the signal line terminal 512 at the internal wiring 58 side and is coupled to the signal line 581. Further, the power line terminal of the first connector 51 has the power line terminal 513 at the internal wiring 58 side and is coupled to the power line 582.

The signal line terminal of the second connector 55 has the signal line terminal 552 at the internal wiring 58 side and is coupled to the signal line 581. Further, the power line terminal of the second connector 55 has the power line terminal 553 at the internal wiring 58 side and is coupled to the power line 582.

According to the configuration, the first connector 51 and the second connector 55 each may be coupled to the signal line 581 and the power line 582 of the internal wiring 58 by the respective signal line terminal and power line terminal, and therefore, assembly work may be simplified for both signal lines and power lines.

In the first drive unit 2 of the embodiment, at least a part of the rotation detector (encoder 28) is covered by the third case 26 and placed at the motor 20 side of the rotation shaft 22, and the rotation of the rotation shaft 22 is detected. Further, in the first drive unit 2, the rotation detecting board (encoder board 29) is separately formed from the first connector 51 and captures the signal from the encoder 28. The rotation detecting board (encoder board 29) is coupled to the first connector 51 and coupled to the signal line 581 of the internal wiring 58.

According to the configuration, for the coupling of the rotation detector (encoder 28), the rotation detecting board (encoder board 29), and the first connector 51 to the signal line 581 of the internal wiring 58, the space for wiring may be made smaller even when the first connector 51 and the rotation detecting board (encoder board 29) are separately formed.

In the first drive unit 2 of the embodiment, the supporting member 40 as the case has the attachment plate 45 between the case (supporting member 40) of the motor 20 and the attachment portion 351 of the reducer 30 in the direction along the center axis A of the rotation of the rotation shaft 22, and the attachment plate 45 is attached to another member (e.g. the base 10 as the first member).

According to the configuration, the attachment plate 45 is provided, and thereby, the first drive unit 2 may be fixed to the other member (e.g. the base 10 as the first member). Note that the attachment plate 45 is conformed to the shape of the other member, and thereby, the degree of freedom of the attachment to the other member to fix is increased.

The robot 1 of the embodiment includes the above described first drive unit 2, the base 10 as the first member having the base housing 101 as the first housing passing the first wiring 53 therethrough, and the first arm 11 as the second member having the first arm housing 111 as the second housing passing the second wiring 57 therethrough and relatively rotating to the first member. Further, the motor 20 of the first drive unit 2 is fixed to the first member (base 10) and the output portion (flexible gear 33) is fixed to the second member (first arm 11).

According to the configuration, the robot 1 having the easily replaceable first drive unit 2 and rotating the second member (first arm 11) relative to the first member (base 10) may be realized.

In the robot 1 of the embodiment, the second member (first arm 11) has the opening portion 112 and the second connector 55 is placed in the region of the opening portion 112.

According to the configuration, the second wiring 57 may be passed through the second member (first arm 11) from the second connector 55 via the opening portion 112, and therefore, another connector or the like is not necessary and the configuration may be simplified.

### 2. Second Embodiment

In the embodiment, assembly of the second drive unit 3 in the robot 1 will be explained.

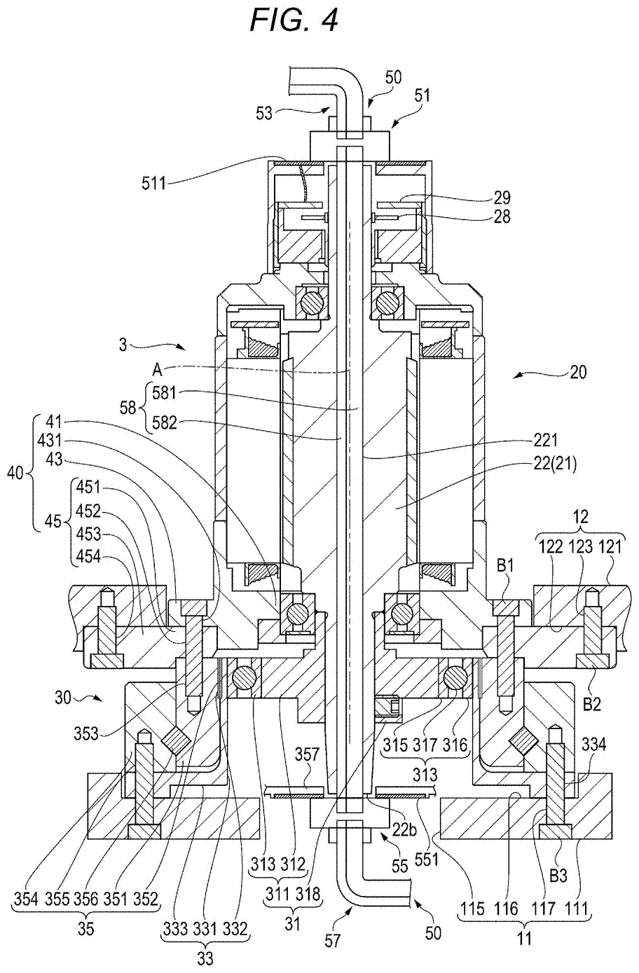

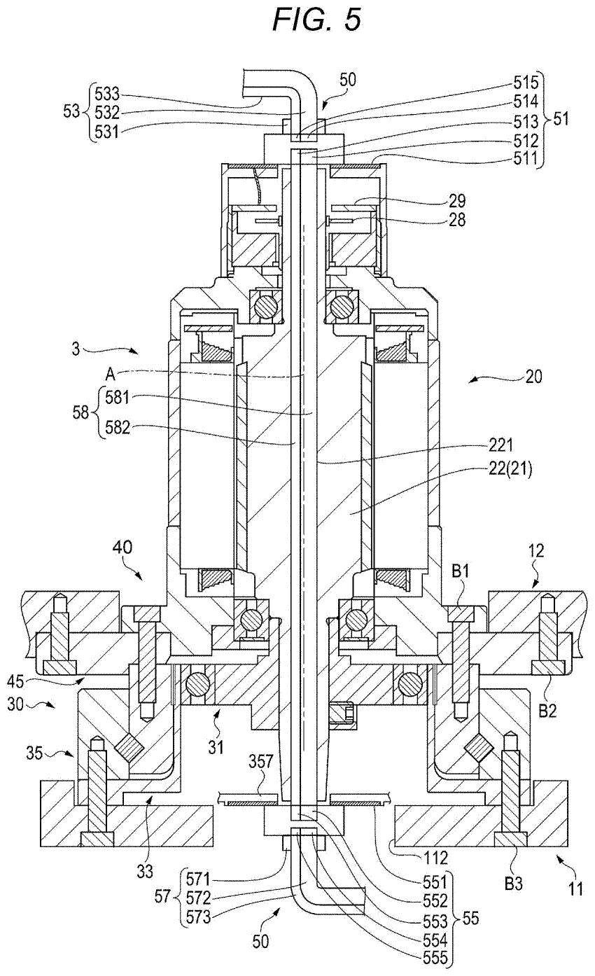

FIGS. 4 and 5 are sectional views showing a schematic configuration of a drive unit (second drive unit 3) according to the embodiment. FIGS. 4 and 5 show sections passing through the second axis J2 and parallel to the XZ-plane. FIG. 4 mainly shows the reducer 30 of the second drive unit 3, the first arm 11, and the second arm 12 with signs attached thereto, and FIG. 5 mainly shows the transmission and reception configuration section 50 of the second drive unit 3 with signs attached thereto.

The second drive unit 3 has the same configuration as the first drive unit 2 as described in the first embodiment, and the differences will be mainly explained. The same configuration portions have the same signs.

The first drive unit 2 of the first embodiment is the drive unit relatively rotating the first arm 11 as the second member to the base 10 as the first member. The second drive unit 3 of the embodiment is the drive unit relatively rotating the first arm 11 as the second member to the second arm 12 as a first member. Note that the first arm 11 rotates around the first axis J1 and the second arm 12 rotates around the second axis J2.

Because of the relative rotation, the second drive unit 3 may be a drive unit relatively rotating the second arm 12 as the first member to the first arm 11 as the second member. In other words, the second arm 12 is rotatable around the second axis J2 relative to the first arm 11.

In the embodiment, the motor 20 is fixed to the second arm 12 as the first member. Specifically, in the second drive unit 3, the attachment plate 45 of the supporting member 40 is fixed to a second arm housing 121 forming the second arm 12.

In the second arm housing 121, fixing screw holes 123 having shapes conformed to the outer diameter of the attachment plate 45 (e.g. step portions 122) are formed correspondingly to the insertion holes 454. The supporting member 40 is fixed to the second arm housing 121 in the manner that the supporting member 40 (attachment plate 45) is positioned in the step portions 122 from the downside of the second arm housing 121, and then, bolts B2 are inserted through the insertion holes 454 from the downside and screwed into the fixing screw holes 123 for fixation. Thereby, the first wiring 53 is routed inside of the second arm 12 as the first member.

In the embodiment, the second drive unit 3 fixes the flexible gear 33 as the output portion to the first arm 11 as the second member. Specifically, in the second drive unit 3, the flexible gear 33 of the reducer 30 is fixed to the first arm housing 111 forming the first arm 11.

In the first arm housing 111, insertion holes 117 having shapes conformed to the outer diameter of the flexible gear 33 (e.g. step portions 116) are formed correspondingly to the insertion holes 334 in addition to an opening portion 115, which will be described later. The flexible gear 33 is fixed to the first arm 11 in the manner that the flexible gear 33 (flange portion 333) is positioned in the step portions 116 from the upside of the first arm housing 111, and then, bolts B3 are inserted through the insertion holes 117, 334 from the downside and screwed into the fixing screw holes 355 for fixation. Thereby, the second wiring 57 is routed inside of the first arm 11 as the second member.

By the assembly, in the embodiment, the drive force by the rotation of the motor 20 fixed to the second arm 12 is input to the wave generator 31 and, when the wave generator 31 rotates, the first arm 11 fixed to the flexible gear 33 rotates around the center axis A (second axis J2) relative to the second arm 12. When the first arm 11 is fixed, the second arm 12 rotates around the center axis A (second axis J2).

A configuration and an operation of the transmission and reception configuration section 50 will be explained.

The transmission and reception configuration section 50 of the second drive unit 3 has the same configuration as the transmission and reception configuration section 50 of the first embodiment. Further, the second connector 55 of the second drive unit 3 is placed in the region of the opening portion 115 formed in the first arm housing 111 of the first arm 11 to which the output side of the second drive unit 3 is fixed.

As shown in FIG. 5, the second connector 55 is coupled to the second wiring 57 (second connecting portion 571) coupled to the outside. Here, “outside” corresponds to the second connector 55 of the first drive unit 2 in the embodiment. Note that the second wiring 57 coupled to the second connector 55 of the second drive unit 3 is coupled to the second wiring 57 of the first drive unit 2 and finally coupled to the second connector 55 of the first drive unit 2.

The first connector 51 of the second drive unit 3 is coupled to the first wiring 53 (first connecting portion 531) coupled to the outside. Here, when a hand (not shown) or the like is provided as an end effector of the robot 1, “outside” corresponds to a circuit board (not shown) transmitting and receiving information of a force sensor in the embodiment.

As an operation of the transmission and reception configuration section 50 in the second drive unit 3, for example, a case where a signal for an instruction to detect the rotation speed of the motor 20 of the second drive unit 3 is received from the control apparatus 19 will be explained.

First, the signal for the instruction to detect the rotation speed is received via the second wiring 57 (second signal line 572) of the first drive unit 2. Specifically, the second connector 55 of the second drive unit 3 receives an optical signal input from the second wiring 57 (second signal line 572) by the signal line terminal 554 and the second transmitting and receiving circuit board 551 controls the signal line terminal 552 to emit light and outputs an optical signal to the internal wiring 58 (signal line 581).

Then, the first connector 51 receives and inputs the optical signal via the internal wiring 58 (signal line 581) by the signal line terminal 512, and the first transmitting and receiving circuit board 511 converts the received optical signal into an electrical signal and transmits the signal to the encoder board 29. The first transmitting and receiving circuit board 511 converts the data of the rotation speed received from the encoder board 29 into an optical signal by the signal line terminal 512 and outputs the optical signal to the internal wiring 58 (signal line 581).

The second connector 55 of the second drive unit 3 receives the optical signal input from the internal wiring 58 (signal line 581) by the signal line terminal 552, and the second transmitting and receiving circuit board 551 outputs the signal from the signal line terminal 554 to the second wiring 57 (second signal line 572). The optical signal is transmitted to the control apparatus 19 via the first drive unit 2.

As an operation of the transmission and reception configuration section 50 in the second drive unit 3, for example, a case where the robot 1 includes a hand (not shown) or the like and transmits information of a force sensor to the control apparatus 19 will be briefly explained.

In this case, the first connector 51 of the second drive unit 3 receives an optical signal output from a circuit board (not shown) transmitting and receiving the information of the force sensor by the signal line terminal 514 via the first wiring 53 (first signal line 532), and outputs the signal to the internal wiring 58 (signal line 581) from the signal line terminal 512. The second connector 55 of the second drive unit 3 receives an optical signal input from the internal wiring 58 (signal line 581) by the signal line terminal 552 and outputs the signal to the second wiring 57 (second signal line 572) from the signal line terminal 554. The optical signal is transmitted to the control apparatus 19 via the first drive unit 2.

As an operation of the transmission and reception configuration section 50 in the second drive unit 3, for example, a case where the motor 20 is driven will be briefly explained.

In this case, drive power (e.g. alternating current) driving the motor 20 of the second drive unit 3 from the control apparatus 19 is transmitted to the second connector 55 (power line terminal 555) of the second drive unit 3 via the first drive unit 2. After transmitted to the first connector 51 via the internal wiring 58 (power line 582) of the second drive unit 3, the drive power is supplied to the stator 23 (coils 232) to rotate the motor 20.

A case where the second drive unit 3 is replaced is briefly explained.

As shown in FIG. 4, when the second drive unit 3 is replaced, the second drive unit 3 is detached from the second arm 12 and the first arm 11.

First, in the second drive unit 3, the first connecting portion 531 coupled to the first connector 51 is pulled out from the first connector 51, and thereby, the first wiring 53 is detached from the second drive unit 3. Similarly, in the second drive unit 3, the second connecting portion 571 coupled to the second connector 55 is pulled out from the second connector 55, and thereby, the second wiring 57 is detached from the second drive unit 3.

Then, the bolts B2 are detached, and thereby, the fixation between the second arm housing 121 and the supporting member 40 is released. Further, the bolts B3 are detached, and thereby, the fixation between the first arm housing 111 and the flexible gear 33 is released.

In the above described manner, the second drive unit 3 may be detached from the second arm 12 and the first arm 11.

According to the embodiment, the same effects as those of the first embodiment may be obtained.

### 3. Third Embodiment

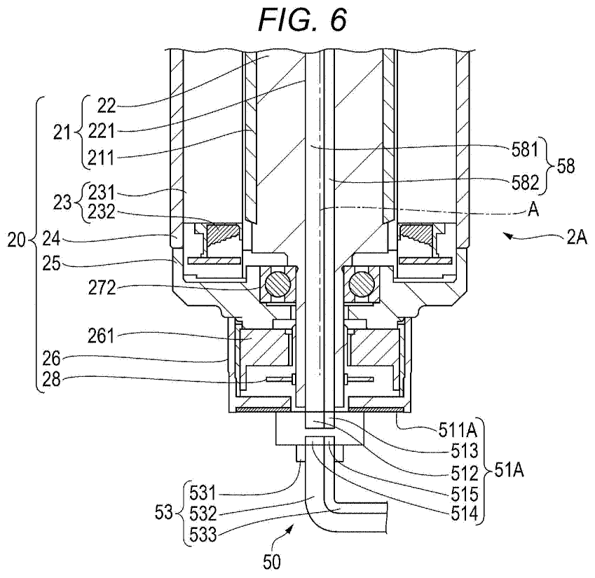

FIG. 6 is a partial sectional view showing a schematic configuration of a drive unit (first drive unit 2A) according to the embodiment.

In the first embodiment, the encoder board 29 forming the first drive unit 2 and the first transmitting and receiving circuit board 511 (first connector 51) of the first connector 51 are separately formed. However, in the first drive unit 2A of the embodiment, as shown in FIG. 6, in a first connector 51A, the encoder board 29 and the first transmitting and receiving circuit board 511 in the first embodiment are integrally formed to configure a new first transmitting and receiving circuit board 511A.

Accordingly, the first transmitting and receiving circuit board 511A has a function as the encoder board 29 e.g. the function of receiving the signal of the first transmitting and receiving circuit board 511 and transmitting the signal from the encoder 28 to the first transmitting and receiving circuit board 511 or the like in the first embodiment. The encoder board 29 and the first transmitting and receiving circuit board 511 of the first embodiment are integrally formed to configure the new first transmitting and receiving circuit board 511A and coupled to the signal line 581 of the internal wiring 58. In other words, the encoder board 29 of the first embodiment is integrally formed with the first connector 51A of the embodiment. Note that the configuration may also be applied in the second drive unit 3.

According to the embodiment, the same effects as those of the first embodiment may be obtained, and additionally, the following effect may be obtained.

In the first drive unit 2A of the embodiment, the encoder board 29 and the first transmitting and receiving circuit board 511 of the first embodiment are integrally formed to configure the new first transmitting and receiving circuit board 511A including the encoder board and coupled to the signal line 581 of the internal wiring 58.

According to the configuration, the distance from the encoder 28 to the first transmitting and receiving circuit board 511A along the center axis A may be shortened and the first drive unit 2A in the direction along the center axis A may be downsized. Further, in comparison to the first embodiment, the space for wiring may be further reduced.

### 4. Fourth Embodiment

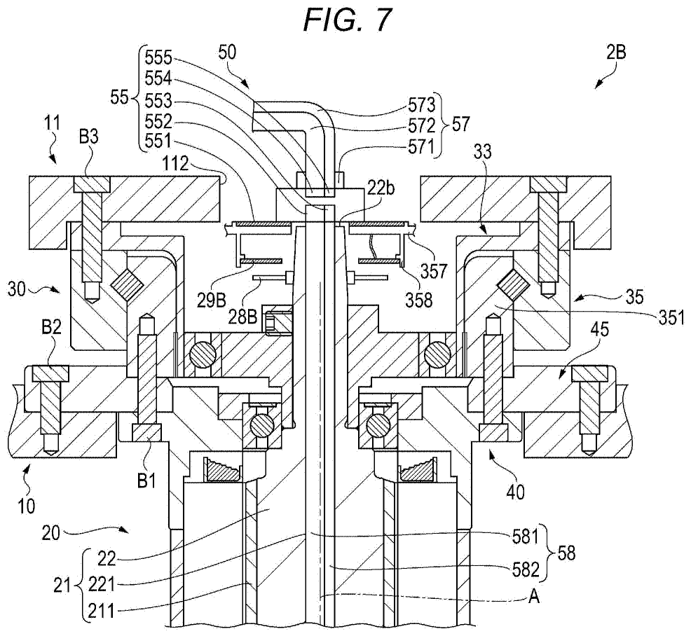

FIG. 7 is a partial sectional view showing a schematic configuration of a drive unit (first drive unit 2B) according to the embodiment.

In the first embodiment, the encoder 28 and the encoder board 29 forming the first drive unit 2 are placed in the end portion of the rotation shaft 22 at the motor 20 side. However, in the first drive unit 2B of the embodiment, as shown in FIG. 7, an encoder 28B and an encoder board 29B are placed in the end portion of the rotation shaft 22 at the reducer 30 side.

As shown in FIG. 7, the encoder 28B as a rotation detector of the embodiment is placed in the end portion of the rotation shaft 22 at the reducer 30 side and detects the rotation of the rotation shaft 22. Further, the encoder board 29B as a rotation detecting board is placed closer to the upper end portion 22b side than the position in the rotation shaft 22 in which the encoder 28B is placed. Note that the functions of the encoder 28B and the encoder board 29B have the same functions as the encoder 28 and the encoder board 29 of the first embodiment.

The encoder board 29B is fixed to a supporting member 358 formed to project from the supporting member 357 provided in the attachment portion 351 of the rigid gear 35 as the fixing portion of the reducer 30. Further, the encoder board 29B is coupled to the second connector 55 (second transmitting and receiving circuit board 551) and coupled to the signal line 581 of the internal wiring 58. Note that the configuration may also be applied in the second drive unit 3.

According to the embodiment, the same effects as those of the first embodiment may be obtained, and additionally, the following effect may be obtained.

In the first drive unit 2B of the embodiment, the encoder 28B as the rotation detector is placed at the reducer 30 side of the rotation shaft 22 and detects the rotation of the rotation shaft 22. Further, the encoder board 29B as the rotation detecting board captures the signal from the encoder 28B and is placed at the reducer 30 side. Furthermore, the encoder board 29B is coupled to the second connector 55 and coupled to the signal line 581 of the internal wiring 58.

According to the configuration, the degree of freedom of placement of the encoder 28B and the encoder board 29B in the first drive unit 2B may be increased.

### 5. Modified Example 1

In the embodiment, the detachment of the first drive unit 2 from the base 10 and the first arm 11 is explained, however, the first drive unit 2 itself may be separated into the motor 20 and the reducer 30 and assembled again. In this case, alignment adjustment of optical axes is unnecessary because the first connector 51 and the second connector 55 are coupled by the internal wiring 58.

### 6. Modified Example 2

In the embodiment, the signal line 581 of the internal wiring 58, the first signal line 532 of the first wiring 53, and the second signal line 572 of the second wiring 57 are formed using optical fibers. However, the signal lines may be formed using normal conducting wires (lead wires) and transmit electrical signals.

### 7. Modified Example 3

In the embodiment, as the robot in which the drive units (first drive unit 2 and second drive unit 3) are assembled, the horizontal articulated robot is explained as an example. However, as the robot in which the drive units (first drive unit 2 and second drive unit 3) are assembled, a vertical articulated robot may be employed and the same effects may be obtained.

What is claimed is:

1. A drive unit comprising:
a motor having a rotation shaft in which a through hole is provided, a drive section rotating the rotation shaft, and a case covering at least a part of the drive section;
a reducer having an input portion engaging with one end portion of the rotation shaft, an attachment portion attached to the motor, and an output portion reducing and outputting rotation of the rotation shaft;
a first connector fixed to the case of the motor and coupled to first wiring coupled to outside;
a second connector fixed to the attachment portion of the reducer and coupled to second wiring coupled to the outside; and
internal wiring passing through the through hole and coupled to the first connector and the second connector.

2. The drive unit according to claim 1, wherein
the internal wiring has a signal line and a power line, and
the first connector and the second connector each have a signal line terminal and a power line terminal and are coupled to the signal line and the power line of the internal wiring.

3. The drive unit according to claim 2, further comprising:
a rotation detector having at least a part covered by the case, placed at the motor side of the rotation shaft, and detecting the rotation of the rotation shaft; and
a rotation detecting board capturing a signal from the rotation detector and formed separately from the first connector, wherein
the rotation detecting board is coupled to the first connector and coupled to the signal line of the internal wiring.

4. The drive unit according to claim 2, wherein
the drive section has:
a rotation detector having at least a part covered by the case and detecting the rotation of the rotation shaft; and
a rotation detecting board capturing a signal from the rotation detector and formed integrally with the first connector, wherein
the rotation detecting board is coupled to the signal line of the internal wiring.

5. The drive unit according to claim 2, further comprising:
a rotation detector detecting the rotation of the rotation shaft; and
a rotation detecting board capturing a signal from the rotation detector and placed at the reducer side, wherein
the rotation detecting board is coupled to the second connector and coupled to the signal line of the internal wiring.

6. A robot comprising:
the drive unit according to claim 1;
a first member having a first housing and passing the first wiring therethrough; and
a second member having a second housing and passing the second wiring therethrough and relatively rotating to the first member, wherein
the motor is fixed to the first member, and
the output portion is fixed to the second member.

7. The robot according to claim 6, wherein
the second member has an opening portion, and
the second connector is placed in a region of the opening portion.

8. The robot according to claim 7, further comprising an attachment plate between the case of the motor and the attachment portion of the reducer in a direction along a center axis of the rotation of the rotation shaft, wherein
the attachment plate is attached to the first member.
